(19) United States
(12) Patent Application Publication
(10) Pub. No.: US 2026/0160625 A1
(43) Pub. Date: Jun. 11, 2026

(54) SENSOR DEVICE

(71) Applicant: Kistler Holding AG, Winterthur (CH)

(72) Inventors: Pirouz Sohi, Winterthur (CH); Hanspeter Oldrati, Wangi (CH); Roland Sommer, Neftenbach (CH); Christoph Naegeli, Wangi (CH)

(21) Appl. No.: 19/406,152

(22) Filed: Dec. 2, 2025

(30) Foreign Application Priority Data
Dec. 6, 2024 (EP) 24217957.0

(51) Int. Cl. G01L 9/00

(52) U.S. Cl. CPC G01L 9/008

(57) ABSTRACT

A sensor device to measure a pressure includes a base body defining a diaphragm on which a thin layer of piezoelectric sensor material is carried to generate charge upon deflection of the diaphragm under the effect of the pressure. A ratio of the diaphragm's thickness to its diameter is configured so that the sensor device has a natural frequency of greater than or equal to 1 MHz.

### TECHNICAL FIELD

The invention relates to a sensor device that detects pressure from charges generated from piezoelectric material and compensates for pyroelectric charges generated during temperature changes.

### BACKGROUND OF THE INVENTION

Sensor devices are well known. They are used in a variety of ways to measure a pressure, a temperature and the like.

Thus, sensor devices are known which measure a pressure according to the piezoelectric measuring principle. For this purpose, they comprise piezoelectric material such as quartz (SiO₂), gallium orthophosphate (GaPO₄) and the like which generates piezoelectric charges under the effect of the pressure to be measured. The piezoelectric charges are generated on the surfaces of the piezoelectric material and are tapped by means of electrodes. The quantity of piezoelectric charges generated is proportional to the magnitude of the measured pressure.

Piezoelectric material such as SiO₂ and GaPO₄ exhibits a very high profile rigidity. Due to this very high profile rigidity, piezoelectric sensor devices have a high natural frequency of more than 500 kilohertz (kHz). Due to this high natural frequency, piezoelectric sensor devices are predestined for dynamic pressure measurements. Generally, the maximum measuring frequency of the sensor device employing piezoelectric material is ⅓ of the natural frequency of the pressure variations being measured by the sensor device.

Such a piezoelectric sensor device for the dynamic measurement of pressure is sold by the applicant under the designation type 603C. In type 603C, the piezoelectric material formed as a plurality of disks is spaced apart in the axial direction from a diaphragm by a base plate. The pressure to be measured acts as a force on the piezoelectric material via said diaphragm and said base plate. As the piezoelectric material such as SiO₂ and GaPO₄ is brittle and can break under local pressure peaks, the base plate ensures an even distribution of the pressure on the piezoelectric material. The maximum measuring frequency of type 603C is about 200 kHz. The technical specifications of type 603C are documented in data sheet No. 603C_003-288e-11.22.

### OBJECTS AND SUMMARY OF THE INVENTION

Now, users of sensor devices for measuring pressure wish to further increase the measurement frequency (also known as the measuring frequency), which is the number of pressure measurements that the sensor device can process per unit of time.

It accordingly is one of principal objects of the present invention to provide a sensor device that achieves a measuring frequency of significantly more than 200 kHz for measuring the pressure.

This principal object is achieved by the features described herein.

The invention relates to a sensor device configured for measuring a pressure and including a base body and at least one sensor material. A region of the base body is devoted to the formation of a base body diaphragm that is configured to undergo a deflection relative to the base body caused by the pressure to be measured. A thin layer of the sensor material is carried by at least one region of the base body diaphragm. This thin layer of sensor material is configured to generate piezoelectric charge by the deflection of said base body diaphragm and in an amount of charge that is proportional to the magnitude of the measured pressure. A formation of compensator material is carried by a separate region of the base body and configured to generate pyroelectric charge under the effect of a temperature change. The pyroelectric charge generated by the compensator material compensates for the pyroelectric charge generated by said sensor material under the change in temperature experienced by the base body and the associated base body diaphragm.

Advantageous embodiments of the invention are described below with greater elaboration on more of their particulars.

### BRIEF DESCRIPTION OF THE DRAWINGS

In the following, the invention is explained in more detail by way of example with reference to the Figures in which

FIG. 1 shows a plan view of a part of a first embodiment of a sensor device 1 with a pressure sensor 1P for measuring a pressure P and with a compensator 1K;

FIG. 2 shows a cross-section of a part of the sensor device 1 as shown in FIG. 1 along a section path B-B.

FIG. 3 shows a plan view of a part of a second embodiment of a sensor device 1 with a group of pressure sensors 1P and with a group of compensators 1K as shown in FIGS. 1 and 2;

FIG. 4 shows a curve of the generation of pyroelectric charge P20+, P30+, P20−, P30− under the effect of a temperature change ΔT of the sensor device 1 as shown in FIGS. 1 to 3;

FIG. 5 shows a schematic circuit diagram of a part of the first embodiment of the sensor device 1 with a pressure sensor 1P and with a compensator 1K as shown in FIGS. 1 and 2, with a transmission device 5, with a transducer unit 6 and with an evaluation unit 7; and

FIG. 6 shows a schematic circuit diagram of a part of the second embodiment of the sensor device 1 with a group of pressure sensors 1P and with a group of compensators 1K as shown in FIG. 3, with a transmission device 5, with a transducer unit 6 and with an evaluation unit 7.

Throughout the figures, identical reference numerals denote identical objects in the Figures.

### DETAILED DESCRIPTION OF EXEMPLARY EMBODIMENTS OF THE INVENTION

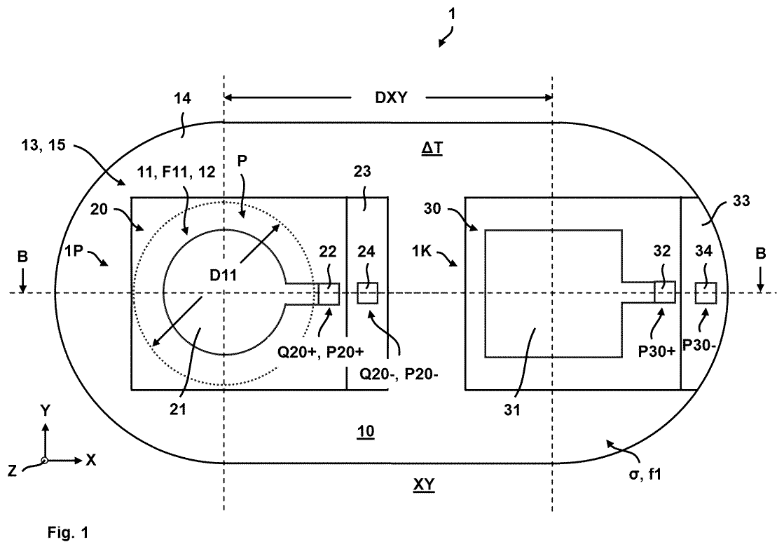

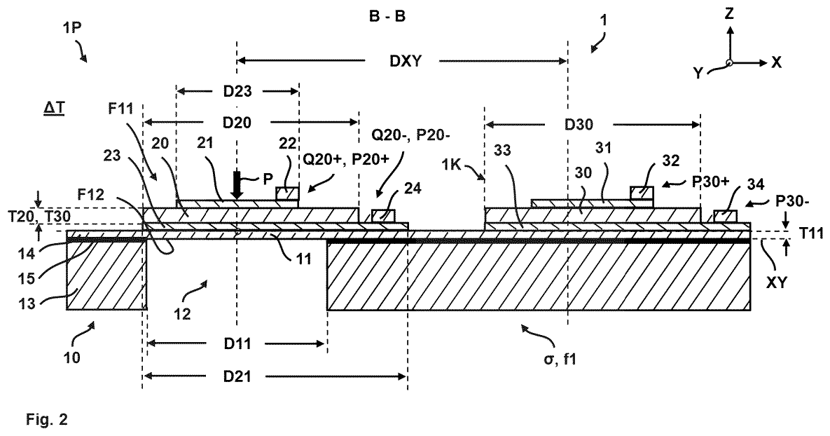

The sensor device 1, which in FIG. 2 is schematically represented in a cross-sectional view looking in the direction of the arrows B, B pointing in FIG. 1, is configured to perform the function of measuring a pressure P that applies a force along the direction of the bold typeface arrow designated P in FIG. 2.

The sensor device 1 comprises at least one pressure sensor 1P for measuring the pressure P and at least one compensator 1K.

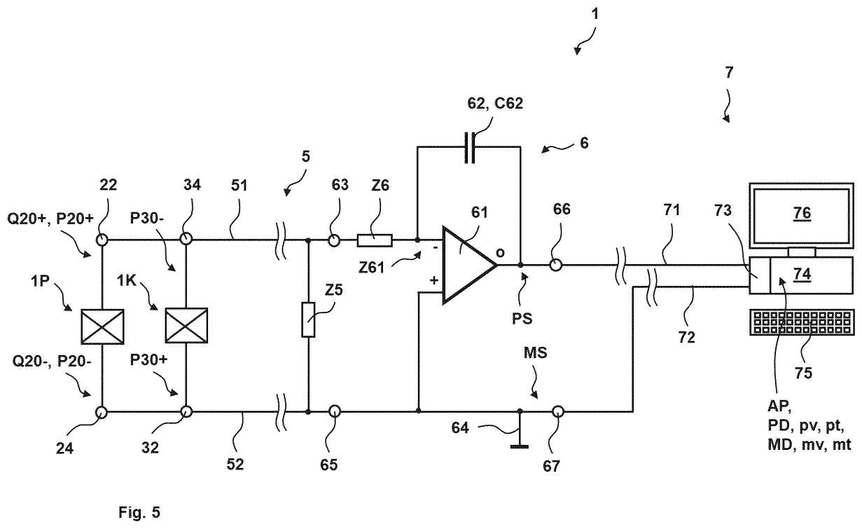

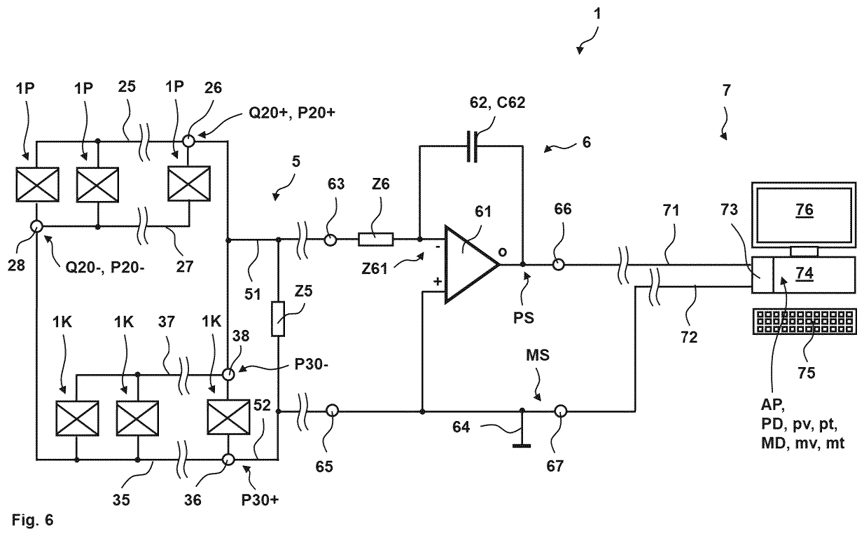

Furthermore, said sensor device 1 as shown in FIGS. 5 and 6 comprises at least one transmission device 5, at least one transducer unit 6 and at least one evaluation unit 7.

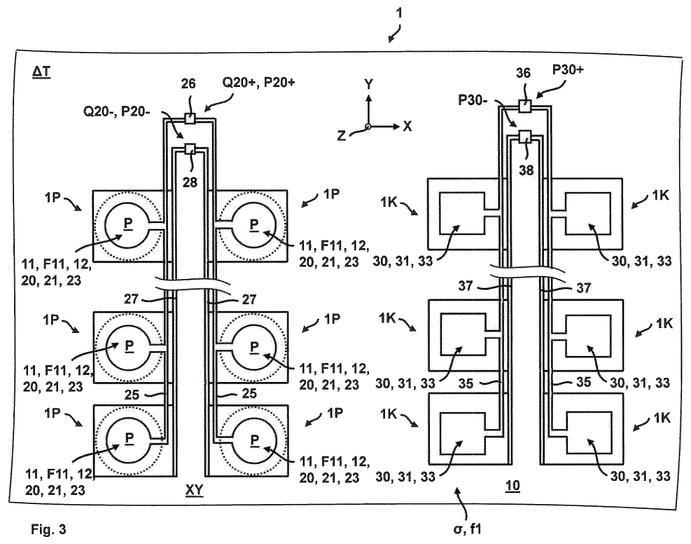

In FIGS. 1 to 3, said sensor device 1 is shown in a three-dimensional coordinate system with a horizontal axis X, a transverse axis Y and a vertical axis Z, also referenced as a longitudinal axis Z. The three axes X, Y, Z are perpendicular to each other. The horizontal axis X and the transverse axis Y define and span a horizontal plane XY. FIGS. 1 and 3 show embodiments of said sensor device 1 in plan view in the horizontal plane XY. FIG. 2 shows the sensor device 1 in cross-section taken in the direction looking along the arrows B, B in FIG. 1.

### The Base Body 10

The sensor device 1 comprises at least one base body 10 that is configured to perform the function of sensing the pressure P to be measured.

Said base body 10 is made of electrically insulating material such as silicon, glass and the like. Silicon has a specific electrical resistance of greater than or equal to 10⁷ ohm-meters (Ωm) at room temperature (20° C.). Glass has a specific electrical resistance of greater than or equal to 10¹¹ Ωm at 20° C.

The base body 10 defines a front side and a rear side disposed opposite to the front side so that the front side and the rear side face away from each other. On the front side, the base body 10 forms a supporting surface. Said supporting surface is located in the horizontal plane XY. Said supporting surface is defined by an area that measures less than or equal to 3 mm*3 mm, preferably less than or equal to 2 mm*2 mm in size. On the rear side, as schematically shown in FIG. 2, the base body 10 forms a base body opening 12 that is defined as a blind hole that extends along the longitudinal axis Z toward the front side of the base body 10 but closed by the base body diaphragm 11.

Preferably, said base body 10 is a Silicon-On-Insulator (SOI) comprising the following functional layers:
A supporting layer 13 is formed of silicon and is defined by a thickness along the vertical axis Z in the range from 200 to 500 μm, preferably the supporting layer 13 has a thickness of 400 μm. The supporting layer 13 is configured to perform a supporting function for components of the sensor device 1.
A boundary layer 14 formed of silicon is defined by a thickness along the vertical axis Z in the range from 100 to 2 μm, preferably a thickness of 50 μm, preferably a thickness of 5 μm. Said boundary layer 14 is configured to perform the function of forming a base body diaphragm 11 in some regions. Said boundary layer 14 is configured to delimit the base body 10 in the horizontal plane XY.
A stop layer 15 is defined by a thickness of 1 micrometer (μm) measured along the vertical axis Z and is disposed along the vertical axis Z between the supporting layer 13 and the boundary layer 14. Said stop layer 15 is formed of an oxide material and has a specific electrical resistance of greater than or equal to 10¹² Ωm at 20° C. Therefore, the function of the stop layer 15 is to electrically insulate the boundary layer 14 from the supporting layer 13. Said stop layer 15 has the further function of providing an etch stop during the production of the base body opening 12 by chemical etching of the base body 10. During production of the base body 10, silicon is etched off on the rear side of the base body 10 along the vertical axis Z up to the stop layer 15.

The base body diaphragm 11 is configured to sense the pressure P to be measured. The base body diaphragm 11 defines two surfaces F11, F12. The two surfaces F11, F12 define a front surface F11 and a rear surface F12 spaced apart from the front surface F11 and disposed opposite the front surface F11. The front surface F11 is located on the front side of the base body 10 in the horizontal plane XY. The pressure P acts along the vertical axis Z onto the front surface F11. The front surface F11 faces the direction in which the pressure P acts. The rear surface of the base body diaphragm 11 defines the base body opening 12 on the rear side of the base body 10. Under the effect of the pressure P, the base body diaphragm 11 is configured so that it can be deflected along the vertical axis Z into the base body opening 12.

The base body diaphragm 11 defines a thickness T11 measured along the longitudinal axis Z of less than or equal to 20 μm, preferably less than or equal to 10 μm, preferably less than or equal to 5 μm. The base body diaphragm 11 has a diameter D11 of less than or equal to 300 μm, preferably less than or equal to 200 μm, preferably less than or equal to 100 μm. The ratio of the thickness T11 to the diameter D11 of the base body diaphragm 11 is configured in such a manner that the sensor device 1 has a natural frequency f1 of greater than or equal to 1 MHz. Advantageously, the ratio of the thickness T11 to the diameter D11 of the base body diaphragm 11 is in the range from 1.7 10⁻² to 5.0 10⁻². Exemplary ratios of thickness T11 to diameter D11 of the base body diaphragm 11 result in the following natural frequencies f1:
For a thickness T11 of the base body diaphragm 11 equal to 5 μm and a diameter D11 of the base body diaphragm 11 equal to 300 μm, the resulting ratio of the thickness T11 to the diameter D11 of the base body diaphragm 11 is equal to 1.7 10⁻² and a resulting natural frequency f1 that is greater than 1 MHz.
For a thickness T11 of the base body diaphragm 11 equal to 5 μm and a diameter D11 of the base body diaphragm 11 equal to 200 μm, the resulting ratio of the thickness T11 to the diameter D11 of the base body diaphragm 11 is equal to 2.5 10⁻² and a resulting natural frequency f1 that is greater than 2.5 MHz.
For a thickness T11 of the base body diaphragm 11 equal to 5 μm and a diameter D11 of the base body diaphragm 11 equal to 100 μm, the resulting ratio of the thickness T11 to the diameter D11 of the base body diaphragm 11 is equal to 5.0 10⁻² and a resulting natural frequency f1 that is greater than 10 MHz.

In contrast to the piezoelectric sensor device of type 603C, which comprises a metallic diaphragm made of stainless steel 17-4PH, the base body diaphragm 11 according to the invention is made of silicon. Compared to stainless steel 17-4PH, which has a density of 7.8 g/cm³, silicon has a density of 2.3 g/cm³. Therefore, said base body diaphragm 11 according to the invention is more than three times lighter, which further increases the natural frequency f1 of the sensor device 1.

### The Sensor Material 20

The sensor device 1 comprises at least one sensor material 20. Said sensor material 20 is configured to perform the function of generating a measured value for the pressure P to be measured.

Said sensor material 20 is piezoelectric, and examples of sensor material include quartz (SiO₂), gallium orthophosphate (GaPO₄), calcium gallo germanate (Ca₃Ga₂Ge₄O₁₄ or CGG), langasite (La₃Ga₅SiO₁₄ or LGS), tourmaline, aluminum nitride (AlN), lead zirconate titanate (PZT), aluminum scandium nitride (Al(1-x)Sc(x)N with x=0 . . . 0.4), potassium sodium niobate (K(x)Na(1-x)NbO3 with x=0.2 . . . 0.5) and the like.

The sensor material 20 is carried on the base body 10. Preferably, said sensor material 20 is disposed to be carried by the front side of the base body 10 via at least one region of the base body diaphragm 11.

The front surface of the base body diaphragm 11 is generally indicated in FIG. 2 by the designation F11. Preferably, as schematically shown in FIG. 2, said sensor material 20 is disposed in some regions above the front surface F11 of the base body diaphragm 11. The sensor material 20 forms a layer extending in the horizontal plane XY. In the horizontal plane XY, the sensor material 20 defines a base area D20. The base area D20 is greater than or equal to the diameter D11 of the base body diaphragm 11. Said sensor material 20 has a constant thickness T20 along the vertical axis Z. The thickness T20 is less than or equal to 10 μm, preferably the thickness T20 is less than or equal to 5 μm, preferably the thickness T20 is less than or equal to 1 μm.

This thickness T20 of the layer of sensor material 20 desirably is formed by a standard sputtering process. For example, for aluminium nitride (AlN) as sensor material 20, a rod made of aluminium (AI) is sputtered with an Argon (Ar) plasma. The aluminum rod is placed next to the whatever surface is to receive the layer of sensor material 20 up to the desired thickness T20. Due to the Argon-sputtering, small aluminum particles are ejected to that receiving surface. The entire set-up (Al-rod and receiving surface) is placed in a Nitrogen (N) atmosphere. In the nitrogen atmosphere, molecular and atomic nitrogen reacts with the aluminum particles and forms aluminum nitride (AlN) that adheres to the receiving surface, which can be a second sensor electrode 23 as schematically shown in FIG. 2 for example.

In contrast to the present invention's thin layer (thickness T20) of sensor material 20 described above, the piezoelectric sensor device of type 603C comprises the sensor material in the form of three disks, each having a thickness of 0.2 mm (200 μm) and being 3.5 mm in diameter. Viewed in the axial direction, the disks are spaced apart from the diaphragm by a metallic base plate having a thickness of 0.6 mm and a diameter of 3.5 mm. In further contrast to the piezoelectric sensor device of type 603, the sensor material 20 is configured according to the invention as a thin layer carried on the base body diaphragm 11. The thickness T20 of the thin layer of the sensor material 20 is less than or equal to 10 μm. This means that there are no disks of sensor material and there is also no metallic base plate so that the weight of the sensor device 1 according to the invention is reduced. Furthermore, since the natural frequency f1 is inversely proportional to the weight of the sensor device 1, the natural frequency f1 of the sensor device 1 increases due to the absence of the disks of sensor material and the metallic base plate that would be present in a device of type 603C.

Under the effect of the pressure P to be measured, said sensor material 20 generates piezoelectric charge Q20+, Q20− as the measured value. The pressure P acts along the vertical axis Z unidirectionally onto the front surface F11 of the base body diaphragm 11 and deflects the base body diaphragm 11. In FIG. 2 the pressure P is schematically shown as an arrow in bold typeface. Said piezoelectric material 20 generates piezoelectric charge Q20+, Q20− as a result of the deflection of the base body diaphragm 11. The amount of the piezoelectric charge Q20+, Q20− generated is proportional to the magnitude of the measured pressure P. The permanent operating temperature of the sensor material 20 is in the range from −40° C. to +500° C.

The piezoelectric charge Q20+, Q20− is generated on a plurality of surfaces of the sensor material 20, which surfaces are disposed parallel to the horizontal plane XY. The piezoelectric charge Q20+, Q20− comprises a first piezoelectric charge Q20+ and a second piezoelectric charge Q20−. In the cross-section shown in FIG. 2, first piezoelectric charge Q20+ is generated on a surface of the sensor material 20 facing away from the base body diaphragm 11, and second piezoelectric charge Q20− is generated on a surface of the sensor material 20 that faces the base body diaphragm 11. According to the following description, the first piezoelectric charge Q20+ is preferably converted into a pressure signal PS, while the second piezoelectric charge Q20− is preferably used as a ground potential signal MS.

The sensitivity a of the sensor device 1 is of great importance. The sensitivity a is the ratio of the measured value to the input value of the pressure P to be measured. The sensitivity a decreases cubically with the increase in the thickness T11 of the base body diaphragm 11. Moreover, the sensitivity a decreases quadratically with the decrease in diameter D11 of the base body diaphragm 11. Thus, the sensitivity a of the sensor device 1 decreases with increase in the ratio of the thickness T11 to the diameter D11 of the base body diaphragm 11.
For a thickness T11 of the base body diaphragm 11 equal to 5 μm and a diameter D11 of the base body diaphragm 11 equal to 300 μm and a resulting ratio of thickness T11 to diameter D11 of the base body diaphragm 11 equal to 1.7 10⁻², the resulting sensitivity a of the sensor device 1 for AlN as the sensor material is about 5 pC/bar.
For a thickness T11 of the base body diaphragm 11 equal to 5 μm and a diameter D11 of the base body diaphragm 11 equal to 200 μm and a resulting ratio of thickness T11 to diameter D11 of the base body diaphragm 11 equal to 2.5 10⁻², the resulting sensitivity σ of the sensor device 1 for AlN as the sensor material is about 0.5 pC/bar.
For a thickness T11 of the base body diaphragm 11 equal to 5 μm and a diameter D11 of the base body diaphragm 11 equal to 100 μm and a resulting ratio of thickness T11 to diameter D11 of the base body diaphragm 11 equal to 5.0 10², the resulting sensitivity a of the sensor device 1 for AlN as the sensor material is about 0.05 pC/bar.

### The Compensator Material 30

The sensor device 1 comprises at least one formation of compensator material 30 that is configured to perform the function of compensating for the pyroelectric effect of the sensor material 20 of said sensor device 1.

Certain sensor material 20 such as CGG, LGS, tourmaline, AlN, PZT, and the like. exhibits the direct and/or indirect pyroelectric effect, according to which a temperature change ΔT leads to the generation of pyroelectric charge P20+, P20−. The pyroelectric charge P20+, P20− is generated on the same surfaces of the sensor material 20 as the piezoelectric charge Q20+, Q20−. Therefore, the measurement of the pressure P is falsified by any change in temperature ΔT. In the embodiments of FIGS. 1 to 3 of the sensor device 1, the sensor material 20 exhibits the pyroelectric effect.

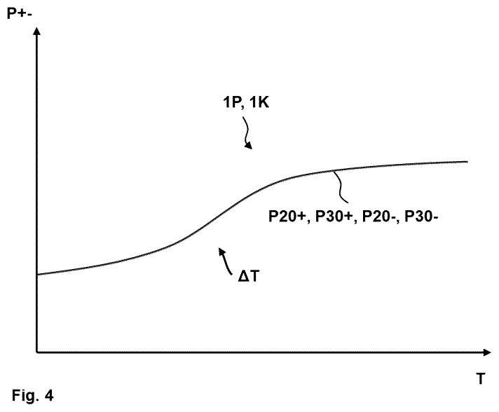

Said compensator material 30 then preferably consists of the same CGS, LGS, tourmaline, AlN, PZT, and the like, as the sensor material 20. FIG. 4 shows a curve of the generation of pyroelectric charge P20+, P30+, P20−, P30− with the temperature change ΔT. The temperature T is plotted on the abscissa over the range of the permanent operating temperature of the sensor material 20 and the compensator material 30 from −40° C. to +500° C. The ordinate shows the pyroelectric charge P+−. The amount of pyroelectric charge P20+, P30+, P20−, P30− generated is proportional to the size of the base area D20 of the sensor material 20 and to the size of a base area D30 of the compensator material 30. For example, for a temperature change ΔT, the curve of the generation of pyroelectric charge P20+, P30+, P20−, P30− is S-shaped. The slope of the curve reflects the sensitivity of the sensor material 20 and the compensator material 30 to the pyroelectric effect. This sensitivity is in the range of from 0.1 pC/° C. to 0.5 pC/° C.

Said formation of compensator material 30 is carried by the base body 10. Preferably, as schematically shown in FIG. 2 for example, the compensator material 30 is carried in at least one region on the front side of the base body 10. Preferably, the compensator material 30 is arranged near the base body diaphragm 11 but spaced apart from the base body diaphragm 11. Said formation of compensator material 30 forms a layer extending in the horizontal plane XY. In the horizontal plane XY, the compensator material 30 covers the base area D30. Preferably, the base area D30 is the same size as the base area D20 covered by the sensor material 20. Along the vertical axis Z, the compensator material 30 has a constant thickness T30. Preferably, the thickness T30 of the compensator material 30 is the same as the thickness T20 of the sensor material 20. The thickness T30 is less than or equal to 10 μm, preferably the thickness T30 is less than or equal to 5 μm, preferably the thickness T30 is less than or equal to 1 μm.

This thickness T30 of the layer of compensator material 30 desirably is formed by a standard sputtering process. For example, for aluminium nitride (AlN) as compensator material 30, a rod made of aluminium (AI) is sputtered with an Argon (Ar) plasma. The aluminum rod is placed next to the whatever surface is to receive the layer of sensor material 20 up to the desired thickness T20. Due to the Argon-sputtering, small aluminum particles are ejected to that receiving surface. The entire set-up (Al-rod and receiving surface) is placed in a Nitrogen (N) atmosphere. In the nitrogen atmosphere, molecular and atomic nitrogen reacts with the aluminum particles and forms aluminum nitride (AlN) that adheres to the receiving surface, which can be second sensor electrode 23 as schematically shown in FIG. 2 for example.

Because the compensator material 30 is arranged outside the base body diaphragm 11, the pressure P to be measured cannot act on the compensator material 30, since said base body 10 does not experience any deflection due to the effect of the pressure P and thus the compensator material 30 does not generate any piezoelectric charge as a measured value. Preferably, the sensor material 20 and the compensator material 30 have an identical structure. Preferably, the size of the base area D20 of the sensor material 20 is equal to the size of the base area D30 of said compensator material 30. Preferably, the ratio of the size of the base area D20 of the sensor material 20 to the size of the base area D30 of the compensator material 30 is known.

Just as with the sensor material 20, which generates the pyroelectric charge P20+, P20− on a plurality of surfaces parallel to the horizontal plane XY, the compensator material 30 also generates the pyroelectric charge P30+, P30− on a plurality of surfaces parallel to the horizontal plane XY. The pyroelectric charge P20+, P30+, P20−, P30− comprises first pyroelectric charge P20+, P30+ and second pyroelectric charge P20−, P30−. In the cross-section of FIG. 2, the first pyroelectric charge P20+ is generated on the surface of the sensor material 20 facing away from the base body diaphragm 11, and the second pyroelectric charge P20− is generated on the surface of the sensor material 20 facing the base body diaphragm 11. In the case of said compensator material 30, first pyroelectric charge P30+ is generated on a surface of compensator material 30 facing away from base body 10, and second pyroelectric charge P30− is generated on a surface of compensator material 30 facing base body 10.

### The Pressure Sensor 1P

Said sensor device 1 comprises a plurality of sensor electrodes 21, 23. Said sensor electrodes 21, 23 are configured to perform the function of tapping the piezoelectric charge Q20+, Q20− from the surfaces of the sensor material 20.

Said sensor electrodes 21, 23 are arranged in the region of the surfaces of the sensor material 20 where piezoelectric charge Q20+, Q20− is generated. The sensor electrodes 21, 23 comprise a first sensor electrode 21 and a second sensor electrode 23. The sensor electrodes 21, 23 are made of electrically conductive material such as silver (Ag), gold (Au), platinum (Pt), and the like and desirably can be created and put in place by any standard process such as chemical vapor deposition, physical vapor deposition or lithography.

In the cross-section of FIG. 2, the first sensor electrode 21 is arranged on the surface of the sensor material 20 facing away from the base body diaphragm 11 and taps the first piezoelectric charge Q20+. The second sensor electrode 23 is arranged on the surface of the sensor material 20 facing the base body diaphragm 11 and taps the second piezoelectric charge Q20−. Each of the two sensor electrodes 21, 23 forms a layer extending parallel to the horizontal plane XY. Parallel to the horizontal plane XY, the first sensor electrode 21 comprises a first sensor base area D21 and the second sensor electrode 23 comprises a second sensor base area D23. Along the vertical axis Z, each of the two sensor electrodes 21, 23 exhibits a constant thickness of 200 nm or less.

Compared to the piezoelectric sensor device of type 603C, the diaphragm of which has a diameter of 5.5 mm, the base body diaphragm 11 according to the invention is about one order of magnitude smaller. The base body diaphragm 11 is miniaturized. The surface of the diaphragm of type 603C has space for more than one hundred base body diaphragms 11 according to the invention. The base body diaphragm 11, the sensor material 20 carried on the base body diaphragm 11 and the sensor electrodes 21, 23 arranged on the surfaces of the sensor material 20 are configured to act in concert to form a miniaturized pressure sensor 1P which not only generates piezoelectric charge Q20+, Q20− for the pressure P to be measured, but which also comprises sensor electrodes 21, 23 in order to tap said piezoelectric charge Q20+, Q20− from the surfaces of the sensor material 20.

The profile rigidity of the base body diaphragm 11 is not constant across its diameter D11. In a central area of the base body diaphragm 11 along the vertical direction Z, the profile rigidity is constant, but in a peripheral region in the transition to the stop layer 15 and to the support layer 13, the profile rigidity increases. As the profile rigidity increases in the peripheral region of said base body diaphragm 11, the sensitivity a of the sensor device 1 and thus also the generation of piezoelectric charge Q20+, Q20− decreases there. This decrease in the sensitivity a of the sensor device 1 in the peripheral region of the base body diaphragm 11 falsifies the measurement of the pressure P. To avoid the decrease in the sensitivity a of the sensor device 1 in the peripheral region of the base body diaphragm 11, preferably no first piezoelectric charge Q20+ is tapped there at all, which first piezoelectric charge Q20+ is preferably used as the pressure signal PS. For this reason, the diameter of the first sensor base area D21, on which the first piezoelectric charge Q20+ is tapped, is smaller than the diameter D11 of the base body diaphragm 11. Preferably, the first sensor base area D21 is less than or equal to 80%, preferably less than or equal to 60% of the diameter D11 of the base body diaphragm 11.

The second sensor base area D23, on the other hand, on which the second piezoelectric charge Q20− is tapped, which second piezoelectric charge Q20− is preferably used as the ground potential signal MS, is preferably greater than or equal to the diameter D11 of the base body diaphragm 11.

The sensor device 1 comprises a plurality of sensor contact points 22, 24 as schematically depicted in FIGS. 1 and 2. Said sensor contact points 22, 24 are configured to perform the function of providing electrical contact between the sensor electrodes 21, 23 and the transmission device 5.

Said sensor contact points 22, 24 consist of electrically conductive material such as Ag, Au, Pt, and the like and desirably can be created and put in place by any standard process such as chemical vapor deposition, physical vapor deposition or lithography.

The sensor contact points 22, 24 comprise a first sensor contact point 22 and a second sensor contact point 24. The first sensor contact point 22 is arranged directly on the first sensor electrode 21 and establishes an electrical contact with the first sensor electrode 21. The second sensor contact point 24 is arranged directly on the second sensor electrode 23 and establishes an electrical contact with the second sensor electrode 23. Each of the two sensor contact points 22, 24 comprises a planar extension parallel to the horizontal plane XY, which is designed to be large enough to accomplish electrical contacting such as thermosonic ball-wedge bonding, ultrasonic wedge-wedge bonding, and the like.

The base body diaphragm 11, the sensor material 20 arranged on the front surface F11 of the base body diaphragm 11 and the sensor electrodes 21, 23 arranged directly on the surfaces of the sensor material 20 act in convert to form the pressure sensor 1P of the embodiments of said sensor device 1 as shown in FIGS. 1 to 3. The piezoelectric charge Q20+, Q20− is the measured value of the pressure sensor 1P. The permanent operating temperature of the pressure sensor 1P is in the range of from −40° C. to +500° C.

### The Compensator 1K

The sensor device 1 comprises a plurality of compensator electrodes 31, 33. Said compensator electrodes 31, 33 are configured to perform the function of tapping the pyroelectric charge P30+, P30− from the surfaces of the compensator material 30. The first sensor electrode 21 taps the first pyroelectric charge P20+, the second sensor electrode 23 taps the second pyroelectric charge P20−.

As schematically depicted in FIGS. 1 and 2, the compensator electrodes 31, 33 are arranged in the region of the surfaces of the compensator material 30 where pyroelectric charge P30+, P30− is generated. The compensator electrodes 31, 33 comprise a first compensator electrode 31 and a second compensator electrode 33. The compensator electrodes 31, 33 are made of electrically conductive material such as Ag, Au, Pt, and the like, just like the sensor electrodes 21, 23 and desirably can be created and put in place by any standard process such as chemical vapor deposition, physical vapor deposition or lithography.

In the cross-section of FIG. 2, the first compensator electrode 31 is arranged on the surface of the compensator material 30 facing away from the base body 10 and taps the first pyroelectric charge P30+. The second compensator electrode 33 is arranged on the surface of the compensator material 30 facing the base body 10 and taps the second piezoelectric charge P30−. Each of the two compensator electrodes 31, 33 forms a layer extending parallel to the horizontal plane XY. Along the vertical axis Z, each of the two compensator electrodes 31, 33 exhibits a constant thickness of 200 nm or less.

In said sensor material 20, the pyroelectric charge P20+, P20− is tapped together with the piezoelectric charge Q20+, Q20− by the sensor electrodes 21, 23.

Preferably, said sensor electrodes 21, 23 and the compensator electrodes 31, 33 exhibit an identical structure. Preferably, the size of the area of the sensor electrodes 21, 23 is equal to the size of the area of the compensator electrodes 31, 33. Preferably, the ratio of the size of the area of the sensor electrodes 21, 23 to the size of the area of the compensator electrodes 31, 33 is known.

The sensor device 1 comprises a plurality of compensator contact points 32, 34 like the ones schematically shown in FIGS. 1 and 2. Said compensator contact points 32, 34 are configured to perform the function of providing electrical contact between the compensator electrodes 31, 33 and the transmission device 5.

The compensator contact points 32, 34 consist of electrically conductive material such as Ag, Au, Pt, and the like, just like the sensor contact points 22, 24 and desirably can be created and put in place by any standard process such as chemical vapor deposition, physical vapor deposition or lithography.

The compensator contact points 32, 34 comprise a first compensator contact point 32 and a second compensator contact point 34. The first compensator contact point 32 is arranged directly on the first compensator electrode 31 and establishes an electrical contact with the first compensator electrode 31. The second compensator contact point 34 is arranged directly on the second compensator electrode 33 and establishes an electrical contact with the second compensator electrode 33. Each of the two compensator contact points 32, 34 comprise a planar extension parallel to the horizontal plane XY, which is designed to be large enough to accomplish electrical contacting such as thermosonic ball-wedge bonding, ultrasonic wedge-wedge bonding, and the like.

The region of the base body 10 in which the compensator material 30 is located, the compensator material 30 arranged on the base body 10 and the compensator electrodes 31, 33 arranged on the surfaces of the compensator material 30 are configured to act in concert to form the compensator 1K of the embodiments of the sensor device 1 as shown in FIGS. 1 to 3. The permanent operating temperature of the compensator 1K is in the range from −40° C. to +500° C.

Advantageously, said compensator 1K is arranged at a first horizontal distance DXY of less than/equal to 2 mm from the pressure sensor 1P. This small first horizontal distance DXY ensures that the temperature change ΔT acts equally on the sensor material 20 of the pressure sensor 1P and on the compensator material 30 of the compensator 1K and generates pyroelectric charge P20+, P20− in the sensor material 20 and pyroelectric charge P30+, P30− in the compensator material 30.

Advantageously, the sensor material 20 generates a plurality of piezoelectric charges Q20+, Q20− under the effect of the pressure P and a plurality of pyroelectric charges P20+, P20− under the effect of the temperature change ΔT. For a measuring frequency f* of at most ⅓ of the natural frequency f1 of greater than or equal to 1 MHz, the plurality of piezoelectric charges Q20+, Q20− of the sensor material 20 exhibits 10⁶ piezoelectric charges Q20+, Q20− per second and the plurality of pyroelectric charges K20+, K20− of the sensor material 20 exhibits 10⁶ pyroelectric charges P20+, P20− per second. The compensator material 30 generates a large number of pyroelectric charges P30+, P30− under the effect of the temperature change ΔT. For a measuring frequency f* of at most ⅓ of the natural frequency f1 of greater than or equal to 1 MHz, the plurality of pyroelectric charges P30+, P30− of the compensator material 30 exhibits 10⁶ pyroelectric charges P30+, P30− per second. For each pyroelectric charge P20+, P20− of the sensor material 20, there is a time-corresponding pyroelectric charge P30+, P30− of the compensator material 30.

### The Group of Pressure Sensors 1P

According to the second embodiment schematically shown in FIGS. 3 and 6, the sensor device 1 comprises a base body 10 with a plurality of base body diaphragms 11.

Preferably, as schematically shown in FIG. 3, the plurality of base body diaphragms 11 is arranged on the front side of the base body 10 lying in the horizontal plane XY. The pressure P to be measured acts along the vertical direction Z on the front surfaces F11 of the plurality of base body diaphragms 11 and deflects the plurality of base body diaphragms 11. On each of the plurality of base body diaphragms 11, said sensor material 20 is arranged in at least one area on the front surface F11 of the base body diaphragm 11. The sensor material 20 generates piezoelectric charge Q20+, Q20− as a result of the deflection of said base body diaphragm 11. On each of the plurality of base body diaphragms 11, the first sensor electrode 21 is arranged on the surface of the sensor material 20 facing away from the base body diaphragm 11 and taps the first piezoelectric charge Q20+. The second sensor electrode 23 is arranged on the surface of the sensor material 20 facing the base body diaphragm 11 and taps the second piezoelectric charge Q20−.

According to the second embodiment, the sensor device 1 comprises a plurality of sensor group conductors 25, 27. The sensor group conductors 25, 27 are configured to perform the function of collecting the piezoelectric charge Q20+, Q20− that has been tapped and gathered by the sensor electrodes 21, 23 from the surface of the piezoelectric material 20.

The sensor group conductors 25, 27 consist of electrically conductive material such as Ag, Au, Pt, and the like and desirably can be created and put in place by any standard process such as chemical vapor deposition, physical vapor deposition or lithography.

The sensor group conductors 25, 27 are arranged in the region of the two surfaces of the sensor material 20. The sensor group conductors 25, 27 comprise a first sensor group conductor 25 and a second sensor group conductor 27. The first sensor group conductor 25 establishes an electrical contact with the first sensor electrodes 21 and establishes an electrical contact with them in series. The second sensor group conductor 27 establishes an electrical contact with the second sensor electrodes 23 and connects them electrically in series.

The plurality of base body diaphragms 11 on which sensor material 20 is carried on front surfaces F11, the sensor material 20 carried on the plurality of base body diaphragms 11 and the sensor electrodes 21, 23 and sensor group conductors 25, 27 arranged on the surfaces of this sensor material 20 are configured to act in concert to form a group of pressure sensors 1P.

Advantageously, a plurality of greater than or equal to two base body diaphragms 11, preferably a plurality of greater than or equal to sixteen base body diaphragms 11, preferably a plurality of greater than or equal to 128 base body diaphragms 11 is formed in the base body 10.

The increase in the natural frequency f1 of the sensor device 1 according to the invention is achieved by a decrease in the ratio of thickness T11 to diameter D11 of the base body diaphragm 11, but the sensitivity a of the sensor device 1 according to the invention decreases as well. The sensitivity a changes quadratically with the diameter D11 of the base body diaphragm 11. If the thickness T11 is kept constant, halving the diameter D11 of the base body diaphragm 11 results in a quartering of the amount of piezoelectric charge Q20+, Q20− generated. By arranging a plurality of base body diaphragms 11 in the base body 10, with sensor material 20 being carried on each front surface F11 of the plurality of base body diaphragms 11, and the series connection of the sensor electrodes 21, 23, which tap the piezoelectric charge Q20+, Q20− of the sensor material 20, the decrease in sensitivity a of the sensor device 1 according to the invention can be compensated for, and the sensitivity a of the sensor device 1 can even become increased.

According to the second embodiment, the sensor device 1 comprises a plurality of sensor group contact points 26, 28. Said sensor group contact points 26, 28 are configured to perform the function of providing an electrical contact with the transmission device 5.

The sensor group contact points 26, 28 are made of electrically conductive material such as Ag, Au, Pt, and the like and desirably can be created and put in place by any standard process such as chemical vapor deposition, physical vapor deposition or lithography.

The sensor group contact points 26, 28 comprise a first sensor group contact point 26 and a second sensor group contact point 28. The first sensor group contact point 26 is arranged on the first sensor group conductor 25 and establishes an electrical contact with the first sensor group conductor 25. The second sensor group contact point 28 is arranged on the second sensor group conductor 27 and establishes an electrical contact with the second sensor group conductor 27. Each of the two sensor group contact points 26, 28 has a planar extension parallel to the horizontal plane XY, which is designed to be large enough to accomplish electrical contacting such as thermosonic ball-wedge bonding, ultrasonic wedge-wedge bonding, and the like.

### The Group of Compensators 1K

According to the second embodiment, said sensor device 1 comprises a base body 10 with a plurality of regions with compensator material 30.

Preferably, the plurality of regions with compensator material 30 is carried on the front side of the base body 10. Both the compensator material 30 and the sensor material 20 are preferably made of the same CGS, LGS, tourmaline, AlN, PZT, and the like with pyroelectric effect.

The regions comprising compensator material 30 are spaced apart from each other and thus electrically insulated to each other by the electrically insulating material of said base body 10. Preferably, the plurality of regions with compensator material 30 is carried spaced apart from the plurality of base body diaphragms 11. Thus, the regions with compensator material 30 are also electrically insulated from the sensor material 20 carried on the plurality of base body diaphragms 11 by the electrically insulating material of the base body 1.

Since the plurality of regions with compensator material 30 is carried spaced apart from the plurality of base body diaphragms 11, the pressure P to be measured cannot act on the plurality of regions with compensator material 30, because the base body 10 does not experience any deflection due to the action of the pressure P and thus the plurality of regions with compensator material 30 does not generate a piezoelectric charge as a measured value.

A temperature change ΔT equally acts on the sensor material 20 carried on the plurality of base body diaphragms 11 and on the plurality of regions with compensator material 30 and generates pyroelectric charge P20+, P20− in both the sensor material 20 and pyroelectric charge P30+, P30− in said compensator material 30. Preferably, said sensor material 20 and the compensator material 30 are configured with an identical structure, so that the amount of pyroelectric charge P20+, P20− generated in the sensor material 20 is equal to the amount of pyroelectric charge P30+, P30− generated in the compensator material 30.

On each of the plurality of base body diaphragms 11, the first sensor electrode 21 is arranged directly on the surface of the sensor material 20 facing away from the base body diaphragm 11 and taps first pyroelectric charge P20+. Said second sensor electrode 23 is arranged directly on the surface of the sensor material 20 facing the base body diaphragm 11 and taps the second pyroelectric charge P20−. On each of the plurality of regions with compensator material 30, the first compensator electrode 31 is arranged directly on the surface of the compensator material 30 facing away from the base body 10 and taps first pyroelectric charge P30+. The second compensator electrode 33 is arranged directly on the surface of the compensator material 30 facing the base body 10 and taps the second pyroelectric charge P30−.

According to the second embodiment, said sensor device 1 comprises a plurality of compensator group conductors 35, 37. The compensator group conductors 35, 37 are configured to perform the function of collecting the pyroelectric charge P30+, P30−.

The compensator group conductors 35, 37 consist of electrically conductive material such as Ag, Au, Pt, and the like.

The compensator group conductors 35, 37 are arranged in the region of the two surfaces of the compensator material 30. The compensator group conductors 35, 37 comprise a first compensator group conductor 35 and a second compensator group conductor 37. The first compensator group conductor 35 establishes an electrical contact with the first compensator electrodes 31 and electrically connects them in series. The second compensator group conductor 37 establishes an electrical contact with the second compensator electrodes 33 and connects them electrically in series.

The regions of the base body 10 on which the plurality of regions with compensator material 30 are carried, the plurality of regions with compensator material 30, and the compensator electrodes 31, 33 and compensator group conductors 35, 37 arranged on the surfaces of these regions with compensator material 30 are configured to act in concert to form a group of compensators 1K.

According to the second embodiment, the sensor device 1 comprises a plurality of compensator group contact points 36, 38. The compensator group contact points 36, 38 are configured to perform the function of providing an electrical contact with the transmission device 5.

The compensator group contact points 36, 38 consist of electrically conductive material such as Ag, Au, Pt, and the like and desirably can be created and put in place by any standard process such as chemical vapor deposition, physical vapor deposition or lithography.

The compensator group contact points 36, 38 comprise a first compensator group contact point 36 and a second compensator group contact point 38. The first compensator group contact point 36 is arranged on the first compensator group conductor 35 and establishes an electrical contact with the first compensator group conductor 35. The second compensator group contact point 38 is arranged on the second compensator group conductor 37 and establishes an electrical contact with the second compensator group conductor 37. Each of the two compensator group contact points 36, 38 comprises a planar extension parallel to the horizontal plane XY, which is designed to be large enough to accomplish electrical contacting such as thermosonic ball-wedge bonding, ultrasonic wedge-wedge bonding, and the like.

### The Transmission Device 5

The transmission device 5 is configured to perform the function of transmitting the piezoelectric charge Q20+, Q20− and pyroelectric charge P20+, P20−, P30+, P30−.

The transmission device 5 comprises a plurality of charge transmitters 51, 52 made of electrically conductive material such as copper (Cu), Ag, Au, and the like. The charge transmitters 51, 52 desirably are wires typically 15 to 200 μm in diameter.

The charge transmitters 51, 52 comprise a first charge transmitter 51 and a second charge transmitter 52.

According to the schematic circuit diagram of FIG. 5, the first charge transmitter 51 establishes an electrical contact with the first sensor electrode 21 via the first sensor contact point 22 and establishes an electrical contact with the second compensator electrode 33 via the second compensator contact point 34. Thus, first piezoelectric charge Q20+ and first pyroelectric charge P20+ of the sensor material 20 and second pyroelectric charge P30− of the compensator material 30 are present at the first charge transmitter 51. Advantageously, the amount of the first pyroelectric charge P20+ of the sensor material 20 is equal to the amount of the second pyroelectric charge P30− of the compensator material 30, so that the pyroelectric charges P20+, P30− on the first charge transmitter 51 electrically neutralize each other and accordingly compensate each other.

According to the schematic circuit diagram of FIG. 5, the second charge transmitter 52 establishes an electrical contact with the second sensor electrode 23 via the second sensor contact point 24 and establishes an electrical contact with the first compensator electrode 31 via the first compensator contact point 32. Thus, second piezoelectric charge Q20− and second pyroelectric charge P20− of the sensor material 20 and first pyroelectric charge P30+ of the compensator material 30 are present at the second charge transmitter 52. Advantageously, the amount of the second pyroelectric charge P20− of the sensor material 20 is equal to the amount of the first pyroelectric charge P30+ of the compensator material 30, so that the pyroelectric charges P20−, P30+ at the second charge transmitter 52 electrically neutralize each other and accordingly compensate each other.

The piezoelectric charge Q20+, Q20− is transmitted from the sensor contact points 22, 24 via said charge transmitters 51, 52.

According to the schematic circuit diagram of FIG. 6, the first charge transmitter 51 establishes an electrical contact with the first sensor group contact point 26 and with the second compensator group contact point 38. Thus, first piezoelectric charge Q20+ and first pyroelectric charge P20+ of the sensor material 20 and second pyroelectric charge P30− of the compensator material 30 are present at the first charge transmitter 51. Advantageously, the amount of the first pyroelectric charge P20+ of said sensor material 20 is equal to the amount of the second pyroelectric charge P30− of the compensator material 30, so that the pyroelectric charges P20+, P30− on the first charge transmitter 51 electrically neutralize each other and accordingly compensate each other.

According to the schematic circuit diagram of FIG. 6, the second charge transmitter 52 establishes an electrical contact with the second sensor group contact point 28 and with the first compensator group contact point 36. Thus, second piezoelectric charge Q20− and second pyroelectric charge P20− of the sensor material 20 and first pyroelectric charge P30+ of the compensator material 30 are present at the second charge transmitter 52. Advantageously, the amount of the second pyroelectric charge P20− of the sensor material 20 is equal to the amount of the first pyroelectric charge P30+ of the compensator material 30, so that the pyroelectric charges P20−, P30+ at the second charge transmitter 52 electrically neutralize each other and accordingly compensate each other.

At a measuring frequency f* of clearly over 100 kHz, a wave impedance Z5 of the transmission device 5 must be taken into consideration. This is because the piezoelectric charge Q20+, Q20− of the charge transmitters 51, 52 generates a magnetic field and thus an inductance. And the charge transmitters 51, 52 form a capacitance in relation to each other. The wave impedance Z5 is dependent on both the inductance and the capacitance of the transmission device 5. The wave impedance Z5 leads to electromagnetic waves, which are reflected at the ends of said transmission device 5. The reflections of the electromagnetic waves can distort the measurement of the pressure P. To avoid such reflections, at least one end of the transmission device 5 is electrically terminated with an electrical resistor. The electrical resistor absorbs incoming electromagnetic waves. Said electrical resistance corresponds to the wave impedance Z5 of the transmission device 5. Depending on the industry standard, the wave impedance Z5 for a transmission device 5 in the form of a coaxial line is 50Ω or 75Ω and for a transmission device 5 in the form of a two-wire line in the range from 100Ω to 300Ω.

### The Transducer Unit 6

The transducer unit 6 is configured to perform the function of electrically transducing transmitted piezoelectric charge Q20+, Q20− into at least one measurement signal PS, MS.

The measurement signal PS, MS comprises a pressure signal PS and a ground potential signal MS. The pressure signal PS corresponds to the first piezoelectric charge Q20+. The ground potential signal MS corresponds to the second piezoelectric charge Q20−.

According to the schematic circuit diagrams of FIGS. 5 and 6, said transducer unit 6 comprises at least one operational amplifier 61, at least one feedback capacitance 62, at least one first charge input contact 63, at least one second charge input contact 65, at least one signal output contact 66 and at least one ground potential output contact 67.

The operational amplifier 61 comprises an inverting input i−, a non-inverting input i+ and a signal output o. The inverting input i− is configured with a high electrical insulation with a low leakage current of 10⁻¹⁴ A (amperes) or less. The inverting input i− of the converter unit 6 has an input impedance Z61 which is close to zero ohms (0Ω). The non-inverting input i+ is connected to a ground potential 64 of the sensor device 1. The ground potential 64 is an electrical reference potential such as zero volts (0 V). The ground potential 64 can be the electrical potential of the electrically conductive ground at the location of said sensor device 1.

The charge input contacts 63, 65 have the function of providing an electrical contact between the transducer unit 6 and the transmission device 5. The charge input contacts 63, 65 consist of electrically conductive material such as Cu, Ag, Au, and the like.

The first charge transmitter 51 is configured to form one end of the transmission device 5 of the inverting input i− of the operational amplifier 61. The first charge transmitter 51 is electrically contacted with the inverting input i− of the operational amplifier 61 via the first charge input contact 63. Thus, the second piezoelectric charge Q20+ of the pressure sensor 1P and the group of pressure sensors 1P are electrically transmitted to the inverting input i− of the operational amplifier 61. The transmitted second piezoelectric charge Q20+ becomes an electric current at the inverting input i−.

The second charge transmitter 52 is electrically contacted with the ground potential 64 via the second charge input contact 65. Thus, the first piezoelectric charge Q20− of the pressure sensor 1P and the group of pressure sensors 1P are at the ground potential 64.

The function of the operational amplifier 61 is to amplify piezoelectric charge Q20+ that is transmitted to the inverting input i−.

The operational amplifier 61 attempts to adjust the voltage difference between the inverting input i− and the non-inverting input i+ to zero. In order to accomplish this, the piezoelectric charge Q20+ to be amplified flows from the inverting input i− into the operational amplifier 61 as an electric current and generates an electrical output voltage at the signal output o.

The operational amplifier 61 is configured to amplify at an operating frequency f61. Said operating frequency f61 is the highest frequency at which the operational amplifier 61 can amplify piezoelectric charge Q20+. Preferably, the operating frequency f61 is greater than or equal to 50 MHz, preferably greater than or equal to 500 MHz.

As schematically depicted in FIGS. 5 and 6, the feedback capacitance 62 is connected in parallel to the inverting input i− and the signal output o of the operational amplifier 61.

The feedback capacitance 62 is configured to perform the function of setting an amplification factor of the transducer unit 6. Said feedback capacitance 62 is connected between the inverting input i− and the signal output o of the operational amplifier 61. The electrical output voltage present at the signal output o flows back to the inverting input i− as an electrical current via the feedback capacitance 62. The amount of electrical current flowing back depends on the magnitude C62 of the feedback capacitance 62. The larger the feedback capacitance 62, the more electrical current flows back to the inverting input i−, which electrical current then flows into the operational amplifier 61 in addition to the piezoelectric charge Q20+ to be amplified. Preferably, the magnitude C62 of the feedback capacitance 62 is in the range from 10 pF to 1000 pF.

The input impedance Z61 at the inverting input i− is inversely proportional to the product of the operating frequency f61 of the operational amplifier 61 and the value C62 of the feedback capacitance 62, and this mathematical relationship can be represented symbolically as follows:

$$Z 61 ∝ \frac{1}{f 61 * C 62}$$

To prevent reflections of the electromagnetic waves in the transmission device 5 and at the inverting input i−, the wave impedance Z5 of the transmission device 5 is balanced to the input impedance Z61 at the inverting input i−. For this purpose, a balancing impedance Z6 is electrically connected between one end of the transmission device 5 connecting to the inverting input i− and the inverting input i− itself as schematically shown in FIGS. 5 and 6. The following mathematical relationship describes the magnitude of the balancing of the wave impedance Z5 of the transmission device 5 in terms of the sum of the input impedance Z61 and the balancing impedance Z6:

$$Z 5 = Z 61 + Z 6$$

The balancing impedance Z6 is of the same order of magnitude as the wave impedance Z5 of said transmission device 5. Preferably, the balancing impedance Z6 is less than or equal to the wave impedance Z5 of transmission device 5. For the wave impedance Z5 of a transmission device 5 in the embodiment of a coaxial line of 50Ω or 75Ω, the balancing impedance Z6 is less than or equal to this wave impedance Z5 of a coaxial line of 50Ω or 75Ω. For the wave impedance Z5 of a transmission device 5 in the form of a two-wire line in the range from 100Ω to 300Ω, the balancing impedance Z6 is less than or equal to this wave impedance Z5 of this two-wire line in the range from 100Ω to 300Ω. Preferably, the balancing impedance Z6 is less than or equal to 300Ω, preferably less than or equal to 75Ω, preferably less than or equal to 50Ω.

To give a numerical example. For a proportionality factor between the input impedance Z61 at the inverting input i− and the product of the operating frequency f61 of the operational amplifier 61 and the value C62 of the feedback capacitance 62 of 2π, as well as an operating frequency f61 of the operational amplifier 61 of 500 MHz and a value C62 of the feedback capacitance 62 of 100 pF, an input impedance Z61 at the inverting input i− of 3.2Ω applies. For balancing with a wave impedance Z5 of said transmission device 5 in the embodiment of a coaxial line of 50Ω, the balancing impedance Z6 is then 46.8Ω.

The pressure signal PS is the electrical output voltage present at the signal output o of the operational amplifier 61. The pressure signal PS corresponds to the amount of the first piezoelectric charge Q20+. Each first piezoelectric charge Q20+ is amplified by the transducer unit 6 into a pressure signal PS.

The signal output contact 66 and the ground potential output contact 67 are configured to perform the function of providing electrical contact between the transducer unit 6 and the evaluation unit 7. The signal output contact 66 and the ground potential output contact 67 are made of electrically conductive material such as Cu, Ag, Au, and the like.

The signal output o of the operational amplifier 61 is electrically connected to the signal output contact 66. The pressure signal PS is applied to the signal output contact 66. The ground potential output contact 67 is electrically connected to the ground potential 64. The ground potential signal MS is applied to the ground potential output contact 67.

### The Evaluation Unit 7

The evaluation unit 7 is configured to perform the function of evaluating the sensor signals PS, MS.

For this purpose, as schematically depicted in FIGS. 5 and 6, said evaluation unit 7 comprises at least one signal conductor 71, at least one ground potential conductor 72, at least one interface 73, at least one computing unit 74, at least one input unit 75, and at least one output unit 76.

The signal conductor 71 and the ground potential conductor 72 are made of electrically conductive material such as Cu, Ag, Au, and the like and desirably can be created and put in place by any standard process such as chemical vapor deposition, physical vapor deposition or lithography.

At the first signal output contact 66, an electrical contact is established with the signal conductor 71, and at the first ground potential output contact 67, an electrical contact is established with the ground potential conductor 72. The pressure signal PS is transmitted to the interface 73 via said signal conductor 71. The ground potential signal MS is fed to the interface 73 via the ground potential conductor 72.

The interface 73 is configured to perform the function of digitizing the measurement signals PS, MS into digitized measurement data elements PD, MD.

For this purpose, said interface 73 comprises at least one transducer element such as an analog-to-digital transducer, and the like. The transducer element is configured to digitize the measurement signals PS, MS into digitized measurement data elements PD, MD. Each digitized measurement data element PD, MD specifies a measurement data amount pv, my for a measured value. Each digitized measurement data element PD, MD is a binary series of numbers with a resolution of 12 bits, 16 bits, and the like.

The interface 73 also comprises at least one timer, such as a clock, and the like. Said timer is configured to provide each digitized measurement data element PD, MD with an associated time point pt, mt. Each time point pt, mt is a binary series of numbers with a resolution of 12 bits, 16 bits, and the like. The time point pt, mt that becomes associated with a digitized measurement data element PD, MD is hereinafter also referred to as the time point pt, mt associated with the digitized measurement data element PD, MD. At the time point pt, mt, the interface 73 has digitized a sensor signal PS, MS into the measurement data element PD, MD. The time point pt, mt has a temporal resolution which, according to the Nyquist-Shannon sampling theorem, is equal to the reciprocal of twice the measuring frequency f*. For a measuring frequency f* of at most ⅓ of the natural frequency f1 greater than or equal to 1 MHz, the time point pt, mt has a temporal resolution greater than or equal to 3/2 10⁻⁶ sec.

The digitized measurement data elements PD, MD comprise at least one pressure data element PD with a pressure amount pv, and the time points pt, mt comprise at least one pressure time point pt, which is associated with the pressure data element PD. Said interface 73 is configured to digitize each pressure signal PS into a pressure data element PD with a pressure amount pv and provide the pressure data element PD with an associated pressure time point pt.

The measurement data elements PD, MD according to the schematic diagrams in FIGS. 5 and 6 also comprise at least one ground potential data element MD with a ground potential value mv, and the time points pt, mt comprise at least one ground potential time point mt which is associated with the ground potential data element MD.

As schematically depicted in FIGS. 5 and 6, the computing unit 74 comprises at least one data storage device and at least one data processor electrically connected to the data storage device.

The computing unit 74 is configured to include and operate at least one evaluation program AP, which is configured to be stored in the data memory and which the data processor is configured to retrieve from the data memory and operate. The evaluation program AP loaded into the data processor is designed to be operated by the data processor to evaluate the measurement data elements PD, MD with the measurement data values pv, my and the times pt, mt.

The computing unit 74 can be operated via the input unit 75 schematically shown in FIGS. 5 and 6. The verb “operate” means that a human person can enter commands via said input unit 75, which commands are executed by the computing unit 74. The input unit 75 can be a keyboard or a touch-sensitive screen for entering commands. Commands can be entered as character strings via the input unit 75, and the evaluation program AP loaded into the data processor is designed to generate control data for the commands entered. Thus, the command entered may be to switch on or off said sensor device 1, and the evaluation program AP loaded into the data processor is designed to generate control data for the command, which control data switches on or off said sensor device 1.

Additionally, the evaluation program AP loaded into the data processor is configured to graphically display the measurement data elements PD, MD, and the date elements t for evaluation. The output unit 76 can be a screen on which the measurement data elements PD, MD are graphically displayed for human beings.

With knowledge of the present invention, a person skilled in the art can realize a wide variety of variations of the embodiments shown. Thus, the pressure sensor 1P, the transmission device 5, and the transducer unit 6 can be realized in a housing at the location where the pressure P is measured.

### LIST OF REFERENCE SYMBOLS

1 Sensor device
1P Pressure sensor
5 Transmission device
6 Transducer unit
7 Evaluation unit
10 Base body
11 Base body diaphragm
D11 Diameter of base body diaphragm
F11 Front surface of the base body diaphragm
F12 Rear surface of the base body diaphragm
T11 Thickness of the base body diaphragm
12 Base body opening
13 Supporting layer
14 Boundary layer
15 Stop layer
20 Sensor material
D20 Base region of the sensor material
T20 Thickness of the sensor material
21 First sensor electrode
D21 Base region of the first sensor electrode
22 First sensor contact point
23 Second sensor electrode
D23 Base region of the second sensor electrode
24 Second sensor contact point
25 First sensor group conductor
26 First sensor group contact point
27 Second sensor group conductor
28 Second sensor group contact point
30 Compensator material
D30 Base area of the Compensator material
T30 Thickness of the Compensator material
31 First compensator electrode
32 First compensator contact point
33 Second compensator electrode
34 Second compensator contact point
35 First compensator group conductor
36 First compensator group contact point
37 Second compensator group conductor
38 Second compensator group contact point
51 First charge transmitter
52 Second charge transmitter
61 Operational amplifier
− Inverting input
+ Non-inverting input
o Signal output
62 Feedback capacity
C62 Magnitude of the feedback capacity
63 First charge input contact
64 Ground potential
65 Second charge input contact
66 Signal output contact
67 Ground potential output contact
71 Signal conductor
72 Ground potential conductor
73 Interface
74 Computing unit
75 Input unit
76 Output unit
AP Evaluation program
B-B Section path
DXY First horizontal distance
f1 Natural frequency
f* Measuring frequency
f61 Operating frequency
MD Ground potential data element
MS Ground potential signal
mt Ground potential time point
my Ground potential value
P Pressure
P+− Pyroelectric charge
P20+ First pyroelectric charge
P20− Second pyroelectric charge
p30+ First pyroelectric charge
P30− Second pyroelectric charge
PD Pressure data element
PS Pressure signal
pt Pressure time point
pv Pressure value
Q20+ First piezoelectric charge
Q20− Second piezoelectric charge
σ Sensitivity
T Temperature
X Horizontal axis
XY Horizontal plane
Y Transverse axis
Z Vertical axis
Z5 Wave impedance
Z6 Balancing impedance
Z61 Input impedance

What is claimed is:

1. A sensor device designed to measure a pressure, the sensor device comprising:
a base body that defines a base body diaphragm configured to sense the pressure to be measured by yielding to a deflection under the effect of the pressure;
a sensor material disposed on the base body diaphragm and configured to generate piezoelectric charge under the effect of the deflection of the base body diaphragm and in an amount of the generated piezoelectric charge that is proportional to the magnitude of the measured pressure;
a compensator material disposed on the base body;
wherein the sensor material is configured to generate pyroelectric charge under the effect of a temperature change;
wherein the compensator material is configured to generate pyroelectric charge under the effect of a temperature change in a manner such that the pyroelectric charge generated by the compensator material added to the pyroelectric charge generated by the sensor material does not change the amount of the generated piezoelectric charge.

2. The sensor device according to claim 1, wherein the compensator material is disposed on the base body diaphragm.

3. The sensor device according to claim 1, wherein the base body diaphragm defines a thickness measured along a longitudinal axis and a diameter measured in a horizontal plane that is disposed perpendicular to the longitudinal axis;
wherein the thickness of the base body diaphragm is less than/equal to 20 μm;
wherein the diameter of said base body diaphragm is less than/equal to 300 μm; and
wherein a ratio of thickness to diameter of the base body diaphragm is such that the sensor device has a natural frequency greater than or equal to 1 MHz.

4. The sensor device according to claim 1, wherein the base body and the base body diaphragm are made of silicon.

5. The sensor device according to claim 1, further comprising:
a plurality of sensor electrodes;
wherein the sensor material defines a plurality of surfaces on which are disposed the generated piezoelectric charge and the generate pyroelectric charge;
wherein the plurality of sensor electrodes are arranged on the plurality of surfaces of said sensor material and configured to tap the generated piezoelectric charge and the generated pyroelectric charge;
wherein the base body diaphragm, the sensor material arranged on the base body diaphragm, and the plurality of sensor electrodes disposed on the plurality of surfaces of the sensor material form a pressure sensor;
wherein the compensator material defines a plurality of surfaces and is configured to generate the generated pyroelectric charge on the plurality of surfaces;
wherein the sensor device includes a plurality of compensator electrodes that are disposed on the plurality of surfaces of the compensator material and configured to tap the pyroelectric charge; and
wherein a compensator is formed by a region of the base body on which the compensator material is disposed and the plurality of compensator electrodes disposed on the plurality of surfaces of the compensator material.

6. The sensor device according to claim 1, further comprising:
a plurality of base body diaphragms formed at a plurality of regions of said base body, wherein each of the plurality of base body diaphragms is configured to sense the pressure to be measured, and wherein each of the plurality of base body diaphragms is configured to assume a deflection under the effect of the pressure;
wherein sensor material is disposed on each of the plurality of base body diaphragms and configured to generate piezoelectric charge under the effect of the deflection of the plurality of base body diaphragms;
wherein a plurality of regions with compensator material are disposed on said base body;
wherein the compensator material and the sensor material are configured to generate pyroelectric charge under the effect of a temperature change.

7. The sensor device according to claim 6, wherein on each respective one of the plurality of base body diaphragms a plurality of sensor electrodes are disposed on surfaces of the sensor material and configured to tap the generated piezoelectric charge and the generated pyroelectric charge of the sensor material;
wherein the sensor device includes a plurality of sensor group conductors that electrically connect the plurality of sensor electrodes in series;
wherein on each of the plurality of regions on which compensator material is disposed, compensator electrodes are arranged on the surfaces of the compensator material and configured to tap the generated pyroelectric charge of the compensator material; and
wherein the sensor device includes a plurality of compensator group conductors that electrically connect the plurality of compensator electrodes in series.

8. The sensor device according to claim 5, wherein the generated piezoelectric charge of the sensor material includes a first piezoelectric charge and a second piezoelectric charge;
wherein the generated pyroelectric charge of the sensor material includes a first pyroelectric charge and a second pyroelectric charge;
wherein the plurality of sensor electrodes includes a first sensor electrode and a second sensor electrode;
wherein the first sensor electrode is configured to tap the first piezoelectric charge and the first pyroelectric charge of the sensor material;
wherein the second sensor electrode is configured to tap the second piezoelectric charge and the second pyroelectric charge of the sensor material;
wherein the generated pyroelectric charge of the compensator material includes a first pyroelectric charge and a second pyroelectric charge;
wherein the plurality of compensator electrodes includes a first compensator electrode and a second compensator electrode;
wherein the first compensator electrode is configured to tap the first pyroelectric charge of the compensator material; and
wherein the second compensator electrode is configured to tap the second pyroelectric charge of the compensator material.

9. The sensor device according to claim 8, further comprising:
a transmission device that includes a first charge transmitter and a second charge transmitter;
wherein the first charge transmitter is electrically connected to the first sensor electrode and the second compensator electrode;
wherein the first charge transmitter is configured to receive and combine the first piezoelectric charge and the first pyroelectric charge of the sensor material and the second pyroelectric charge of the compensator material;
wherein the sensor material and the compensator material are configured so that the amount of the first pyroelectric charge of the sensor material is equal to the amount of the second pyroelectric charge of the compensator material and the pyroelectric charges are compensated at the first charge transmitter; and
wherein the second charge transmitter is electrically connected to the second sensor electrode and the first compensator electrode;
wherein the second charge transmitter is configured to receive and combine the second piezoelectric charge and the second pyroelectric charge of the sensor material and a first pyroelectric charge of the compensator material;
wherein the sensor material and the compensator material are configured so that the amount of the second pyroelectric charge of the sensor material is equal to the amount of the first pyroelectric charge of the compensator material and the pyroelectric charges are compensated at the second charge transmitter.

10. The sensor device according to claim 9, wherein the charge transmitters are configured to transmit the piezoelectric charge; and wherein one end of the transmission device is electrically terminated with a wave impedance.

11. The sensor device according to claim 10, further comprising:
a transducer unit that includes an operational amplifier and a feedback capacitance;
wherein the operational amplifier includes an inverting input, a non-inverting input and a signal output;
wherein the feedback capacitance is connected between the inverting input and the signal output;
wherein the transmission device is configured to transmit the generated piezoelectric charge to the transducer unit;
wherein the piezoelectric charge includes a first piezoelectric charge, and the operational amplifier is configured to receive the first piezoelectric charge at the inverting input of the operational amplifier; and
wherein the transducer unit is configured to amplify the first piezoelectric charge into a pressure signal and apply the pressure signal to the signal output.

12. The sensor device according to claim 11, wherein the operational amplifier is configured with an operating frequency, wherein the operational amplifier is configured to amplify the first piezoelectric charge into a pressure signal;
the feedback capacitance is configured with a magnitude that determines an amount of the current flowing back through the feedback capacitance to the inverting input, wherein the current flowing back amplifies the first piezoelectric charge;
wherein the operational amplifier and the feedback capacitance are configured so that an input impedance at the inverting input of the operational amplifier is inversely proportional to the product of the operating frequency of the operational amplifier and the magnitude of the feedback capacitance according to the following relation:
$$Z 61 ∝ \frac{1}{f 61 * C 62}$$
where Z61 equals the input impedance of the operational amplifier, f61 equals the operating frequency of the operational amplifier, and C62 equals the magnitude of the feedback capacitance.

13. The sensor device according to claim 12, further comprising:
a balance impedance configured to balance the input impedance at the inverting input of the operational amplifier with the wave impedance of the transmission device;
wherein the balance impedance is electrically connected between the one end of the transmission device to the inverting input of the operational amplifier and the inverting input of the operational amplifier.

14. The sensor device according to claim 13, wherein the balance impedance is on the order of magnitude of the wave impedance of said transmission device.

15. The sensor device according to claim 14, wherein the transmission device includes a coaxial line of 50Ω or 75Ω, wherein the balance impedance is less than or equal to said wave impedance of the coaxial line of 50Ω or 75Ω.

16. The sensor device according to claim 14, wherein the transmission device includes a two-wire line in the range from 100Ω to 300Ω, wherein the balance impedance is less than or equal to said wave impedance of the two-wire line in the range from 100Ω to 300Ω.

17. The sensor device according to claim 12, wherein the operating frequency of the operational amplifier is greater than or equal to ⅓ of the natural frequency of greater than or equal to 1 MHz of the sensor device.
